(19) United States
(12) Patent Application Publication
(10) Pub. No.: US 2008/0022011 A1
(43) Pub. Date: Jan. 24, 2008

(54) CLIENT AND ASSOCIATION DETECTION METHOD THEREOF

(75) Inventor: CHENG-WEN TANG, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/560,862

(22) Filed: Nov. 17, 2006

(30) Foreign Application Priority Data
Jul. 21, 2006 (TW) 095126677

(51) Int. Cl. G06F 15/16

(52) U.S. Cl. 709/236; 709/230

(57) ABSTRACT

A method for detecting an association status between a client and a server is provided. The method includes receiving a management frame; determining a frame state according to the management frame; transmitting a class frame to the server according to the frame state, a class of the class frame being higher than that of a frame corresponding to the frame state; determining whether an expected frame is received; and determining that the server is disassociated with the client if the expected frame is received. A client employing the method is also provided.

### BACKGROUND OF THE INVENTION

1. Field of the Invention

The invention relates to wireless communications, and particularly to a client and an association detection method thereof.

2. Description of Related Art

In a typical wireless local area network (WLAN) composed of a plurality of mobile stations and access points, if one of the access points receives a disassociation frame or a deauthentication frame faked by an attacker, an unwanted disassociation occurs between that access point and mobile stations in association with it. At this point, the mobile stations are not able to receive data from the access point any more. Some important data for the mobile stations may be lost because the access point will not deal with it. Moreover, due to a fact that most mobile stations are lack of an automatic detection function, the mobile stations will not timely recognize that a disassociation has occurred.

### SUMMARY OF THE INVENTION

An exemplary embodiment of the present invention provides a client associated with a server. The client includes a receiving module, a state determination module, a transmission module, a frame determination module, and an association detection module. The receiving module receives a management frame. The state determination module determines a frame state according to the management frame. The transmission module transmits a class frame to the server according to the frame state, a class of the class frame being higher than that of a frame corresponding to the frame state. The frame determination module determines whether an expected frame is received. The status detection module detects an association status between the client and the server according to a determination result of the frame determination module, thus automatic detection of disassociation is provided.

Another exemplary embodiment of the present invention provides a method for automatically detecting an association status between a client and a server. The method includes receiving a management frame; determining a frame state according to the management frame; transmitting a class frame to the server according to the frame state, a class of the class frame being higher than that of a frame corresponding to the frame state; determining whether an expected frame is received; and determining that the server is disassociated with the client if the expected frame is received.

Other advantages and novel features will become more apparent from the following detailed description when taken in conjunction with the accompanying drawings, in which:

### BRIEF DESCRIPTION OF THE DRAWINGS

FIG. 1 is a schematic diagram illustrating an application environment of a wireless local area network of an exemplary embodiment of the present invention;

FIG. 2 is a block diagram of a client of another exemplary embodiment of the present invention;

FIG. 3 is a schematic diagram of a management frame of a further exemplary embodiment of the present invention; and

FIG. 4 is a flowchart of an association detection method of a still further exemplary embodiment of the present invention.

### DETAILED DESCRIPTION OF THE INVENTION

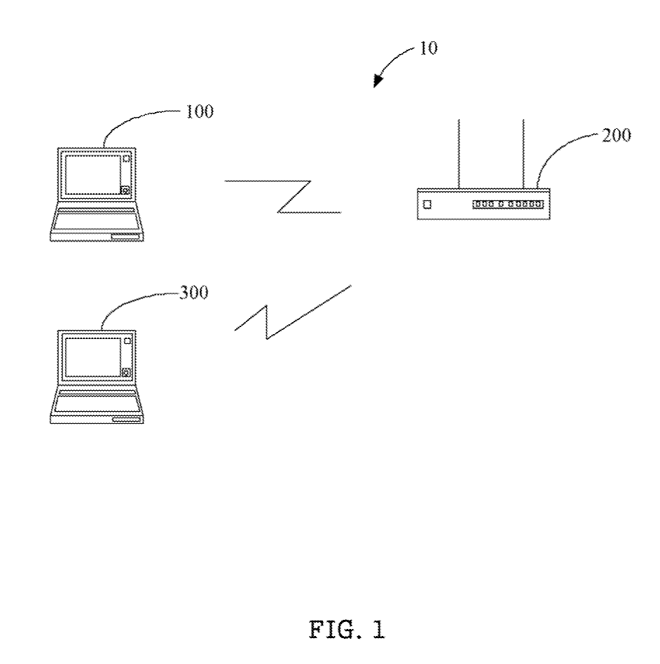

FIG. 1 is a schematic diagram illustrating an application environment of a wireless local area network (WLAN) 10 of an exemplary embodiment of the present invention.

The WLAN 10 includes a client 100, a server 200, and an attacking device 300. In the exemplary embodiment, the client 100 is a mobile station, the server 200 is an access point, and the attacking device 300 is a mobile station with a frame generator.

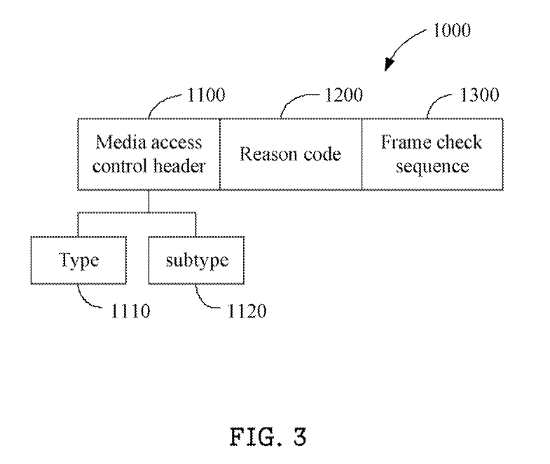

The client 100 is wirelessly communicated to the server 200. The attacking device 300 may transmit a management frame 1000 (A format of which is shown in FIG. 3) to the client 100 in the name of the server 200 by using a media access control (MAC) address of the server 200 commanding an unassociated or unauthenticated state between the client 100 and the server 200.

Upon receiving the management frame 1000, the client 100 determines a frame state according to the management frame, transmits a class frame to the server 200 according to the frame state, and then determines whether an expected frame is received from the server 200, to detect an association status between the client 100 and the server 200.

As defined in the Institute of Electrical and Electronics Engineers (IEEE) 802.11 standard, a frame state includes State 1, State 2, and State 3. State 1 is an unauthenticated and unassociated state between the client 100 and the server 200. State 2 is an authenticated and unassociated state between the client 100 and the server 200. State 3 is an authenticated and associated state between the client 100 and the server 200.

Based on the three states between the client 100 and the server 200, frames transmitted therebetween are accordingly divided into three classes: Class1, Class 2, and Class3, which respectively correspond to State 1, State 2, and State 3.

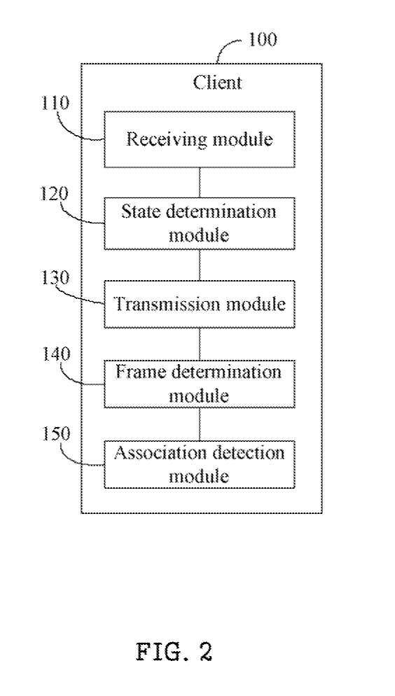

FIG. 2 is a block diagram of the client 100 of another exemplary embodiment of the present invention.

In the exemplary embodiment, the client 100 includes a receiving module 110, a state determination module 120, a transmission module 130, a frame determination module 140, and an association detection module 150.

The receiving module 110 receives a management frame 1000.

The state determination module 120 determines a frame state according to the management frame 1000. In the exemplary embodiment, if the management frame 1000 is a disassociation frame, the frame state is State 2; if the management frame 1000 is a deauthentication frame, the frame state is state 1.

The transmission module 130 transmits a class frame to the server 200 according to the frame state, a class of the class frame being higher than that of a frame corresponding to the frame state. In the exemplary embodiment, Class 3 is the highest class and Class 1 is the lowest class, for example, if the frame state is State 2, the class of the class frame is Class 3; if the frame state is State 1, the class of the class frame is Class 2 or Class 3.

The frame determination module 140 determines whether an expected frame is received, a type of the expected frame being the same as that of the management frame 1000. According to the IEEE 802.11 protocol, if the server 200 receives a frame of Class 3 while in State 2, the server 200 transmits an expected disassociation frame to the client 100; if the server 200 receives a frame of Class 2 or Class 3 while in State 1, the server 200 transmits an expected deauthentication frame to the client 100.

The status detection module 150 detects an association status between the client 100 and the server 200 according to an determination result of the frame determination module 140. In detail, if the frame determination module 140 determines the expected frame is received, the status detection module 150 detects the server 200 is disassociated with the client 100, otherwise the status detection module 150 detects the server 200 is still associated with the client 100.

FIG. 3 is a schematic diagram of a management frame 1000 of an exemplary embodiment of the present invention. In the exemplary embodiment, a source MAC address of the management frame 1000 is a MAC address of the server 200, and the management frame 1000 may be a disassociation frame or a deauthentication frame.

The management frame 1000 includes a media access control (MAC) header field 1100, a reason code field 1200, and a frame check sequence (FCS) field 1300.

The MAC header field 1100 includes a type sub-field 1110 and a subtype sub-field 1120. The type sub-field 1110 and the subtype sub-field 1120 indicate a type of the management frame 1000. When the type sub-field 1110 and the subtype sub-field 1120 are respectively set to 00 and 1010, the management frame 1000 is a disassociation frame; when the type sub-field 1110 and the subtype sub-field 1120 are respectively set to 00 and 1100, the management frame 1000 is the deauthentication frame.

The reason code field 1200 indicates a reason for a disassociation or a deauthentication. In the exemplary embodiment, when the management frame 1000 is the disassociation frame, the reason code field 1200 indicates a reason for the disassociation. When the management frame 1000 is the deauthentication frame, the reason code field 1200 indicates a reason for the deauthentication.

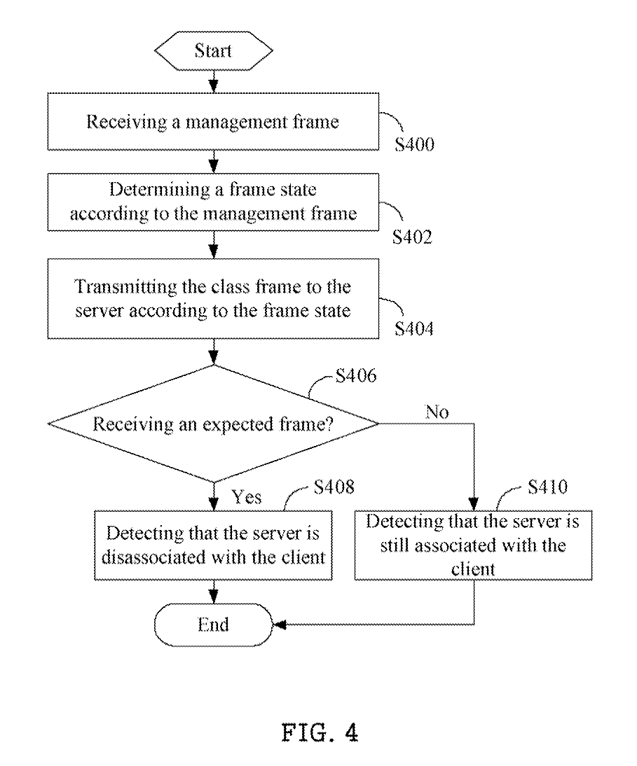

FIG. 4 is a flowchart of an association detection method of a still further exemplary embodiment of the present invention.

In step S400, the receiving module 110 receives the management frame 1000. In the exemplary embodiment, the management frame 1000 is transmitted from an attacking device 300, and may be the disassociation frame or the deauthentication frame. A source MAC address of the management frame 1000 is the same as a MAC address of the server 200.

In step S402, the state determination module 120 determines the frame state according to the management frame 1000. In the exemplary embodiment, if the management frame 1000 is the disassociation frame, the frame state is State 2. If the management frame 1000 is the deauthentication frame, the frame state is State 1.

In step S404, the transmission module 130 transmits the class frame to the server 200 according to the frame state, the class of the class frame being higher than that of the frame corresponding to the frame state. In the exemplary embodiment, Class 3 is the highest class and Class 1 is the lowest class, for example, if the frame state is State 2, the class of the class frame is Class 3; if the frame state is State 1, the class of the class frame is Class 2 or Class 3.

In step S406, the frame determination module 140 determines whether the expected frame is received, i.e., determines what is the response of the server 200 to the claim frame. The type of the expected frame is the same as that of the management frame 1000.

If the expected frame is received, In step S408, the status detection module 150 detects that the server 200 is disassociated with the client 100.

If the expected frame is not received, in step S410, the status detection module 150 detects that the server 200 is still associated with the client 100.

While various embodiments and methods of the present invention have been described above, it should be understood that they have been presented by way of example only and not by way of limitation. Thus the breadth and scope of the present invention should not be limited by the above-described exemplary embodiments, but should be defined only in accordance with the following claims and their equivalents.

What is claimed is:

1. A client associated with a server, comprising:
a receiving module for receiving a management frame;
a state determination module for determining a frame state according to the management frame;
a transmission module for transmitting a class frame to the server according to the frame state, a class of the class frame being higher than that of a frame corresponding to the frame state;
a frame determination module for determining whether an expected frame is received; and
an association detection module for detecting an association status between the client and the server according to a determination result of the frame determination module.

2. The client as claimed in claim 1, wherein the management frame is transmitted from an attacking device.

3. The client as claimed in claim 2, wherein the attacking device is a mobile station with a frame generator.

4. The client as claimed in claim 1, wherein a type of the expected frame is the same as that of the management frame.

5. The client as claimed in claim 1, wherein the client is a mobile station.

6. The client as claimed in claim 1, wherein the server is an access point.

7. The client as claimed in claim 1, wherein a media access control (MAC) address of the server is the same as a source MAC address of the management frame.

8. The client as claimed in claim 1, wherein both the management frame and the expected frame comprise a MAC header field, a reason code field, and a frame check sequence field.

9. The client as claimed in claim 8, wherein the management frame and the expected frame are disassociation frames.

10. The client as claimed in claim 8, wherein the management frame and the expected frame are deauthentication frames.

11. A method for detecting an association status between a client and a server, comprising:
receiving a management frame;
determining a frame state according to the management frame;
transmitting a class frame to the server according to the frame state, a class of the class frame being higher than that of the management frame corresponding to the frame state;
determining whether an expected frame is received; and
detecting that the server is disassociated with the client if the expected frame is received.

12. The method as claimed in claim 11, further comprising detecting that the server is still associated with the client if the expected frame is not received.

13. The method as claimed in claim 11, wherein the management frame is transmitted from an attacking device.

14. The method as claimed in claim 13, wherein the attacking device is a mobile station with a frame generator.

15. The method as claimed in claim 11, wherein a type of the expected frame is the same as that of the management frame.

16. The method as claimed in claim 15, wherein both the management frame and the expected frame comprise a media access control MAC) header field, a reason code field, and a frame check sequence field.

17. The method as claimed in claim 16, wherein the management frame and the expected frame are disassociation frames.

18. The method as claimed in claim 16, wherein the management frame and the expected frame are deauthentication frames.

19. A method for detecting an association status between a client and a server, comprising:
receiving a management frame in a client;
determining a frame state according to said management frame;
transmitting a class frame from said client to a server to be associated by the client according to said frame state; and
detecting an association status between said client and said server based on responses of said server to said class frame.

20. The method as claimed in claim 19, wherein a defined class of said class frame is higher than that of said management frame corresponding to said frame state.
